(19) United States
(12) Patent Application Publication
(10) Pub. No.: US 2011/0061287 A1
(43) Pub. Date: Mar. 17, 2011

(54) DEAD STICK FISHING METHOD AND LURE DEVICE

(76) Inventor: Richard T. OGAWA, Palo Alto, CA (US)

(21) Appl. No.: 12/879,988

(22) Filed: Sep. 10, 2010

Related U.S. Application Data
(60) Provisional application No. 61/242,382, filed on Sep. 14, 2009.

(51) Int. Cl. A01K 85/01; A01K 85/00

(52) U.S. Cl. 43/42.31; 43/17.1; 43/17.5; 43/26.2; 43/4.5

(57) ABSTRACT

A method for dead stick fishing. The method includes casting a lure from a fishing rod to a selected spatial location in a body of water or slightly outside of the body of water. In a specific embodiment, the lure comprises at least a processor device coupled to a sound module and coupled to a lighting module. The method also includes allowing the lure settle and be substantially motionless state, e.g., laying with little or slight movement or suspended or floating with little or slight movement from the angler. The method includes transferring a combination of audio information and electromagnetic radiation from the lure to a region of water surrounding a vicinity of the lure to entice a predator fish to strike the lure while the lure is in the substantially motionless state.

### CROSS-REFERENCES TO RELATED APPLICATIONS

This patent application claims priority to U.S. Ser. No. 61/242,382, filed Sep. 14, 2009 (Attorney Docket No. 019009-001300US), commonly owned, and hereby incorporated by reference herein.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

This present invention relates in general to fishing techniques. More particularly, the present invention provides a fishing lure device and method for attracting and possibly catching predator fish and the like. Merely by way of example, the present device and method can be applied to the field of bass fishing, but it would be recognized that other types of fishing such as salt water, other fresh water, and fishing species that can live in slightly salt water or fresh water environments. The types and varieties of fish can range from black bass, peacock bass, small mouth bass, spotted bass, salmon (e.g., King or Chinook, Silver or Coho, Pink, Chum or Dog, Sockeye) and trout, striper bass, large sunfish (e.g., Red Ear, Blue Gill), crappie, catfish (e.g., Black Bullhead, Brown Bullhead, Channel, Flathead), muskie and pike, and walleye, and other fresh water species listed herein and outside of this specification, as well as salt water species, including cods (e.g., rock, lingcod, china, gopher, vermillion, red, black, yellow), tuna (e.g., albacore, yellow fin, blue fin, black fin) and mackerel, halibut (e.g., Pacific, Calif.), shark, salmon, bass (e.g., calico, black, blue, yellow), grouper, yellowtail, wahoo, commonly called “Ono,” mahi-mahi or dorado or dolphin, marlin, tarpon, sailfish, shark, and others.

The popularity of fishing has increased through the years. One common technique of fishing is called “still fishing.” Still fishing often includes use of live bait, such as a worm, night crawler, grub, minnow, crawfish, or others. Still fishing can successful catch fish such as smaller fresh water panfish including bluegill, crappie, and perch using a small red worm or a larger night crawler, or alternative larger predator fish such as a black, brown, spotted, or striper bass, trout, or other game fish using the same or larger live or even dead baits. As an example, the worm or crawler is commonly attached to a small barbed hook, which is attached to a light line on a fishing pole. The fishing pole is often light and coupled to an open face spinning reel spooled with the light line. The pole and reel was used to cast the worm into a body of water, such as a lake, stream, river, or pond, which hopefully had some fishing to be caught.

Often times, a small float, commonly called a bobber, was placed a predetermined distance from the hook. The bobber floated on the surface of the water, while the worm attached to the hook sank into the depth to lure a predator fish to strike, which was often indicated by the bobber become submersed into the water. Alternatively, the bait was allowed to sink to the bottom of the body of water with the assistance of a small weight attached to the line. The terms “still fishing” literally describe the fisherman's technique of waiting for the fish to strike the worm or other live bait. Although highly successful, other techniques have also been developed.

Artificial lures have been developed to entice a fish to strike. Artificial lures include spoons and spinners, minnow like plugs and crank baits, spinner baits and chatter baits, jigs and soft plastics, including worms, creatures, and crawdads, and most recently swim baits from the Golden State of California. Each of these baits is designed to imitate a bait such as a worm, injured minnow, or others. The baits may include plastics such as the Senko™ plastic worm from Gary Yamamoto in Arizona or from Roboworm Inc. is located in city of Newbury Park, Calif. Hard baits include fat plugs originally from Cotton Cordell and others. Swimbaits were created from a famous lure maker named Ken Huddleston of Southern California. Another famous swimbait is the Lunker Punker™ top water bait by BlackDog Bait Co. of San Ramon, Calif. Although very successful, there are still some limitations. That is, fishing lures still fail to entice a predator fish to strike many times.

As can be seen, techniques for improving ways to catch fish are highly desirable.

### BRIEF SUMMARY OF THE INVENTION

According to the present invention, techniques related to fishing are provided. More particularly, the present invention provides a fishing lure device and method for attracting and possibly catching predator fish and the like. Merely by way of example, the present device and method can be applied to the field of bass fishing, but it would be recognized that other types of fishing such as salt water, other fresh water, and fishing species that can live in slightly salt water or fresh water environments. The types and varieties of fish can range from black bass, peacock bass, small mouth bass, spotted bass, salmon (e.g., King or Chinook, Silver or Coho, Pink, Chum or Dog, Sockeye) and trout, striper bass, large sunfish (e.g., Red Ear, Blue Gill), crappie, catfish (e.g., Black Bullhead, Brown Bullhead, Channel, Flathead), muskie and pike, and walleye, and other fresh water species listed herein and outside of this specification, as well as salt water species, including cods (e.g., rock, lingcod, china, gopher, vermillion, red, black, yellow), tuna (e.g., albacore, yellow fin, blue fin, black fin) and mackerel, halibut (e.g., Pacific, Calif.), shark, salmon, bass (e.g., calico, black, blue, yellow), grouper, yellowtail, wahoo, commonly called “ono,” mahi-mahi or dorado or dolphin, marlin, tarpon, sailfish, shark, and others.

In a specific embodiment, the present invention provides a method for dead stick fishing. The method includes casting a lure from a fishing rod to a selected spatial location in a body of water or slightly outside of the body of water. In a specific embodiment, the lure comprises at least a processor device coupled to a sound module and coupled to a lighting module. The method also includes allowing the lure settle and be substantially motionless state, e.g., laying with little or slight movement or suspended or floating with little or slight movement from the angler. The method includes transferring a combination of audio information and electromagnetic radiation from the lure to a region of water surrounding a vicinity of the lure to entice a predator fish to strike the lure while the lure is in the substantially motionless state.

In an alternative specific embodiment, the present invention provides a method for fishing. The method includes casting a lure from a fishing rod to a selected spatial location in a body of water or slightly outside of the body of water, e.g., a lake, a river, an ocean, a bay, a pond, or creek. In a specific embodiment, the lure comprises at least a processor device coupled to an initiating module and coupled to an output module. The method includes outputting one or more signals from the output module to attract a predator fish using one or more indications from one or more switching devices, the one or more switching devices being provided within the initiating module.

In an alternative specific embodiment, the present invention provides a method of fishing using a deadstick process. The method includes drifting or trolling a lure from a fishing rod to one or more selected spatial locations in a body of water according to one or more embodiments. In a specific embodiment, the lure comprises at least a processor device coupled to a sound module and coupled to a lighting module. The method also includes transferring a combination of at least audio information and electromagnetic radiation from the lure to a region of water within a vicinity of the lure according to a specific embodiment. The method also includes enticing a predator fish to strike the lure while drifting or trolling the lure from the fishing rod.

Still further, the present invention provides a fishing lure device. The device has a body having a first end and a second end. In a specific embodiment, the body is configured in one of a plurality of shapes representative of a bait. The device also has a module region provided within one or more internal portions of the body between the first end and the second end according to a specific embodiment. The module region has a processor device, an audio module coupled to the processing device, a speaker device coupled to the audio module, and one or more memory devices configured with one of a plurality of audio files. In a specific embodiment, the one or more audio files comprises audio information representative of one or more baits, e.g., bait fish, crawdad, frogs, bugs. The module region also includes a lighting module coupled to the processing device according to a specific embodiment. The lighting module is configured to output electromagnetic radiation in one or more of a plurality of wavelengths according to a specific embodiment. The module region includes an energy source coupled to the processing module. The energy source is configured to provide power to the processing module according to one or more embodiments. The device also has a switching device (e.g., accelerometer, transistor) coupled to at least the processing device according to a specific embodiment. The switching device is configured to turn on the processing device upon selected movement of the lure device according to one or more embodiments.

Still further, the present invention provides yet an alternative fishing lure device. The fishing lure device includes a body having a first end and a second end, which may be configured in one of a plurality of shapes. The device also has a module region provided within one or more internal portions of the body between the first end and the second end. In a specific embodiment, the device includes a processor device, e.g., MPU, microcontroller, digital signal processor (DSP). The device has an audio module coupled to the processing device and an audio output device coupled to the audio module according to a specific embodiment. The device also has one or more memory devices configured with one of a plurality of audio files, e.g., MP3. The device has a lighting module coupled to the processing device according to a specific embodiment. The lighting module is configured to output electromagnetic radiation in one or more of a plurality of wavelengths according to one or more embodiments. The device also has an energy source (e.g., battery, generator) coupled to the processing module. In one or more preferred embodiments, the device has a sensor device coupled to at least the processing device. In a preferred embodiment, the sensor device is a motion sensor such as an accelerometer, which is configured to detect one of a plurality of modes. In a preferred embodiment, the motion sensor is configured to output a plurality of indications representing, respectively, the plurality of modes, e.g., sinking, swimming, suspending, floating, casting, jerking, striking, or twitching. Of course, there can be other variations, modifications, and alternatives.

Moreover, the present invention provides a method for fishing using one or more sensor devices. The method includes determining at least one of a plurality of outputs based upon at least one of a plurality of inputs derived from one or more sensor devices according to one or more embodiments. Each of the inputs is representative of a lure state according to one or more embodiments. The method also includes outputting one or more signals from an output module based upon the one of the plurality of inputs to attract a predator fish according to one or more embodiments. Of course, there can be other variations, modifications, and alternatives.

One or more benefits may be achieved using one or more of the specific embodiments. As an example, the present device and method provides for an improved fishing technique with improved efficiencies. In other embodiments, the present method and resulting structure are easy to implement using conventional computer hardware and software technologies. In a preferred embodiment, the present method and system uses a combination of one or more signals, e.g., audio, radiation, mechanical, to entice a fish to strike using at least a dead stick process, but can be others. Depending upon the embodiment, one or more of these benefits can be achieved. These and other benefits are further described throughout the present specification and more particularly below.

The present invention achieves these benefits and others in the context of known process technology. However, a further understanding of the nature and advantages of the present invention may be realized by reference to the latter portions of the specification and attached drawings.

### BRIEF DESCRIPTION OF THE DRAWINGS

FIG. 1 is a simplified diagram of a conventional fishing technique;

FIG. 2 is a simplified illustration of a dead stick fishing technique according to an embodiment of the present invention;

FIG. 3 is a simplified diagram of a dead stick bait capable of imitating feed for a predator fish according to an embodiment of the present invention;

FIG. 4 is a block diagram of an electronic module for the dead stick bait according to an embodiment of the present invention; and

FIGS. 5 through 7 are simplified diagrams of methods of dead stick fishing according to embodiments of the present invention.

### DETAILED DESCRIPTION OF THE INVENTION

According to the present invention, techniques related to fishing are provided. More particularly, the present invention provides a fishing lure device and method for attracting and possibly catching predator fish and the like. Merely by way of example, the present device and method can be applied to the field of bass fishing, but it would be recognized that other types of fishing such as salt water, other fresh water, and fishing species that can live in slightly salt water or fresh water environments. The types and varieties of fish can range from black bass, peacock bass, small mouth bass, spotted bass, salmon (e.g., King or Chinook, Silver or Coho, Pink, Chum or Dog, Sockeye) and trout, striper bass, large sunfish (e.g., Red Ear, Bluegill), crappie, catfish (e.g., Black Bullhead, Brown Bullhead, Channel, Flathead), muskellunge or muskie and pike, and walleye, and other fresh water species listed herein and outside of this specification, as well as salt water species, including cods (e.g., rock, lingcod, china, gopher, vermillion, red, black, yellow), tuna (e.g., albacore, yellow fin, blue fin, black fin) and mackerel, halibut (e.g., Pacific, Calif.), shark, salmon, bass (e.g., calico, black, blue, yellow), grouper, yellowtail, wahoo, commonly called “ono,” mahi-mahi or dorado or dolphin, marlin, tarpon, sailfish, shark, and others.

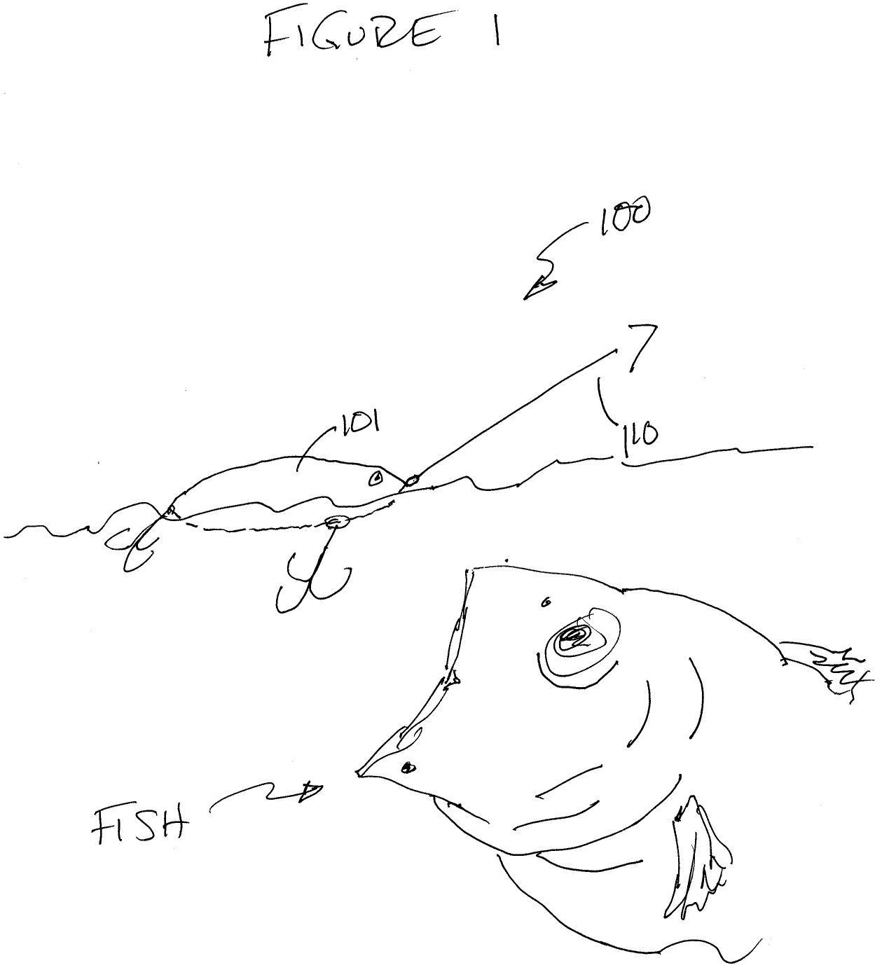

FIG. 1 is a simplified diagram 100 of a conventional fishing technique. As shown, the conventional fishing technique using lures 101 often relies upon movement of the lure by retrieving, jerking, or pulling 110 to cause the lure to dance and imitate a wounded or moving bait fish or the like. As an example, the conventional fishing technique for black bass includes using crank baits, spinner baits, frogs, and soft plastics, which are generally moved through the body of water. Although highly successful, the conventional technique has limitations. That is, the conventional technique may not be effective in all cases, and is prone to difficulties during times when the black bass are not actively feeding. These and other limitations may be overcome by way of the present method and device. A further description of the present invention can be found throughout the present specification and more particularly below.

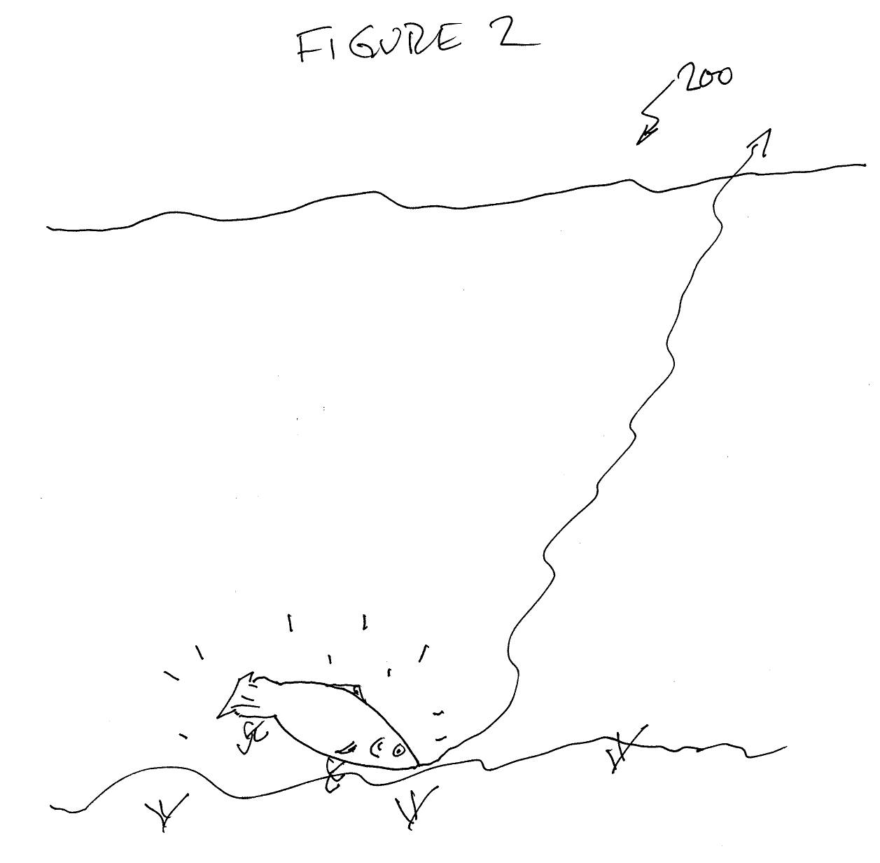

FIG. 2 is a simplified illustration of a dead stick fishing technique 200 according to an embodiment of the present invention. This diagram is merely an example, which should not unduly limit the scope of the claims herein. One of ordinary skill in the art would recognize other variations, modifications, and alternatives. As shown, the dead stick fishing technique can rely upon a variety of lure shapes, sizes, and configurations. As an example, dead stick fishing according to the present invention includes soft baits, such as worms, tubes, creatures, jigs, crawdads, minnows or bait fish, frogs, and other baits. In other embodiments, the present invention includes hard baits, such as top water stick baits, pointers, poppers, frogs, crawlers, and the like. In still other embodiments, sinking and/or diving baits can be included. Of course, there can be other variations, modifications, and alternatives.

As shown, in each of these embodiments, the present fishing technique includes use of casting out the present lure, allowing the lure to settle, with or without movement to one or more locations, and leaving the lure in a substantially motionless state or with slight motion of the lure in one or more embodiments. Once the lure settles, the present fishing lure emits selected wavelengths of electromagnetic radiation in combination with acoustic sounds that imitate baits and/or other entities that attract predatory fish or the like. In a specific embodiment, the selected wavelengths of electromagnetic radiation include those in the blue, green, blue/green, violet, and ultraviolet range of wavelengths, including combinations thereof. Of course, there can be other variations, modifications, and alternatives.

In still other preferred embodiments, actual bait fish or baits within a region of a body of water are imaged using cameras and other imaging devices. The images are processed to determine which one or more combinations of selected wavelengths of electromagnetic radiation are reflected and/or emitted from the bait fish according to one or more embodiments. In a specific embodiment, other living entities, including predatory fish are imaged, which are processed. In a preferred embodiment, the present method uses a process of at least three light emitting devices, including red, green, and blue, which could be selectively combined. In a specific embodiment, the selective combination is used to produce a selected color to be emitted from the fishing lure. In a preferred embodiment, the selected color is combined with acoustic information that are emitted from the fishing lure.

In a specific embodiment, the acoustic sound can be any one or more combinations of sounds and/or mechanical vibration that may attract a predatory fish. In a specific embodiment, the sounds can be derived from actual bait fish and/or imitate actual bait fish in other embodiments. In yet other embodiments, the sounds can be derived from other baits, which are not fish, including worms, frogs, snakes, birds, bugs, dragon flies, turtles, flies, ducks/birds, and others. Still further, the sounds can include mechanical vibrations of selected one or more frequencies according to other embodiments. Of course, there can be other variations, modifications, and alternatives. Further details of the present fishing method and related device can be found throughout the present specification and more particularly below.

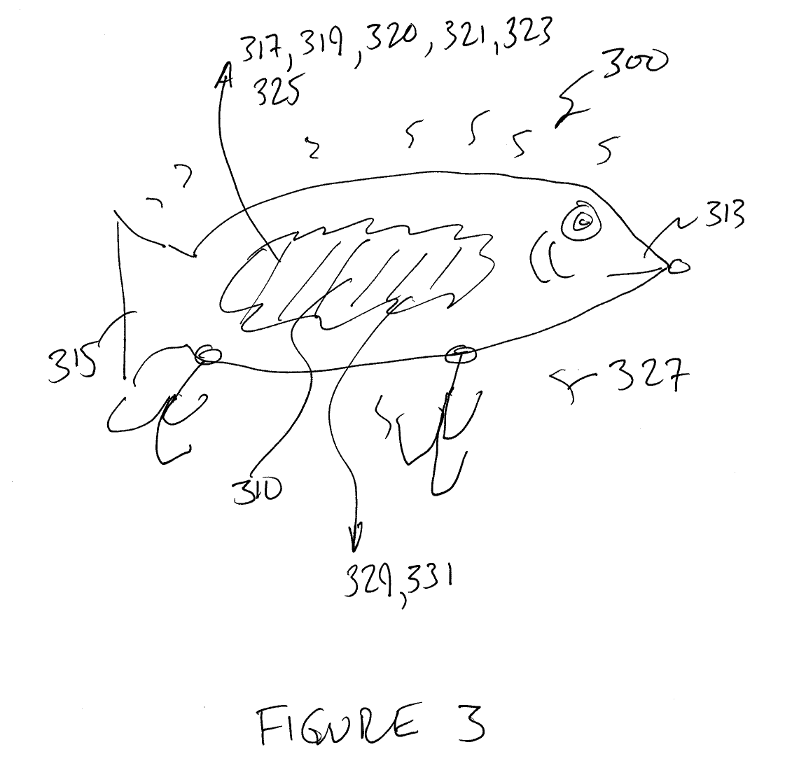

FIG. 3 is a simplified diagram of a dead stick bait 300 capable of imitating feed for a predator fish according to an embodiment of the present invention. This diagram is merely an example, which should not unduly limit the scope of the claims herein. One of ordinary skill in the art would recognize other variations, modifications, and alternatives. As shown, the bait includes the present invention provides a fishing lure device 300. The device has a body having a first end and a second end. In a specific embodiment, the body is configured in one of a plurality of shapes representative of a bait. Of course, there can be other variations, modifications, and alternatives.

In a specific embodiment, the device 300 also has a module region 310 provided within one or more internal portions of the body between the first end 313 and the second end 315 according to a specific embodiment. In a preferred embodiment, the module region is substantially water tight and protects one or more of the electronic and/or mechanical modules. In other embodiments, each of the modules is substantially sealed and maintains water and other fluids away. Of course, there can be other variations, modifications, and alternatives.

In a specific embodiment, the module region includes various electronic/mechanical modules. The module region has a processor device 317, an audio module 319 coupled to the processing device, a speaker device 320 coupled to the audio module, and one or more memory devices 321 configured with one of a plurality of audio files 323. In a specific embodiment, the one or more audio files comprises audio information representative of one or more baits, e.g., bait fish, birds, crawdad, frogs, bugs. The module region also includes a lighting module 325 coupled to the processing device according to a specific embodiment. The lighting module is configured to output electromagnetic radiation 327 in one or more of a plurality of wavelengths according to a specific embodiment. Of course, there can be other variations, modifications, and alternatives.

In one or more embodiments, the module region includes an energy source 329 coupled to the processing module. The energy source is configured to provide power to the processing module according to one or more embodiments. In a specific embodiment, the energy source can be a battery, a capacitor, a generator, or a combination of these. In a specific embodiment, the power can also come from a solar cell coupled to a battery or other device. Additionally, the power source may also come from a propeller or other power generating device coupled to a generator in a specific embodiment. The device also has a switching device 331 (e.g., transistor) coupled to at least the processing device according to a specific embodiment. In a specific embodiment, the switching device is coupled to one or more sensor devices, which can identify one of a plurality of modes, e.g., casting, sinking, twitching, swimming, falling, suspending, striking, resting. Of course, there can be other variations, modifications, and alternatives.

In a specific embodiment, the sensing device can include motion (e.g., accelerometer, gyroscope), optical, capacitance, resistance, mechanical, combinations thereof, and others. An example of an accelerometer is one manufactured by Freescale Semiconductor of Austin, Tex., USA. That is, the accelerometer can include a 3-axis digital accelerometer using micro-electromechanical system (MEMS) technology such as the MMA7455L and MMA7456L accelerometers. In one or more embodiments, the accelerometers provide a digital output, a capability that eliminates the need for an extra analog-to-digital (A/D) converter and enables flexible board layout options. Of course, there can be other variations, modifications, and alternatives.

The sensing and switching devices are configured to turn on the processing device upon selected movement or other internal or external indications of the lure device according to one or more embodiments. Using an accelerometer, for example, the lure is cast, which actuates the accelerometer. The accelerometer causes production of a voltage signal that selectively turns on the processor or other electronic device to begin a sequence of light emission and/or acoustic noise and/or vibration for a predetermined amount of time or other period. In other embodiments, the switching device is configured to also turn off the processing device upon other indications, which may be internal or external. Further details of the present device and be found throughout the present specification and more particularly below.

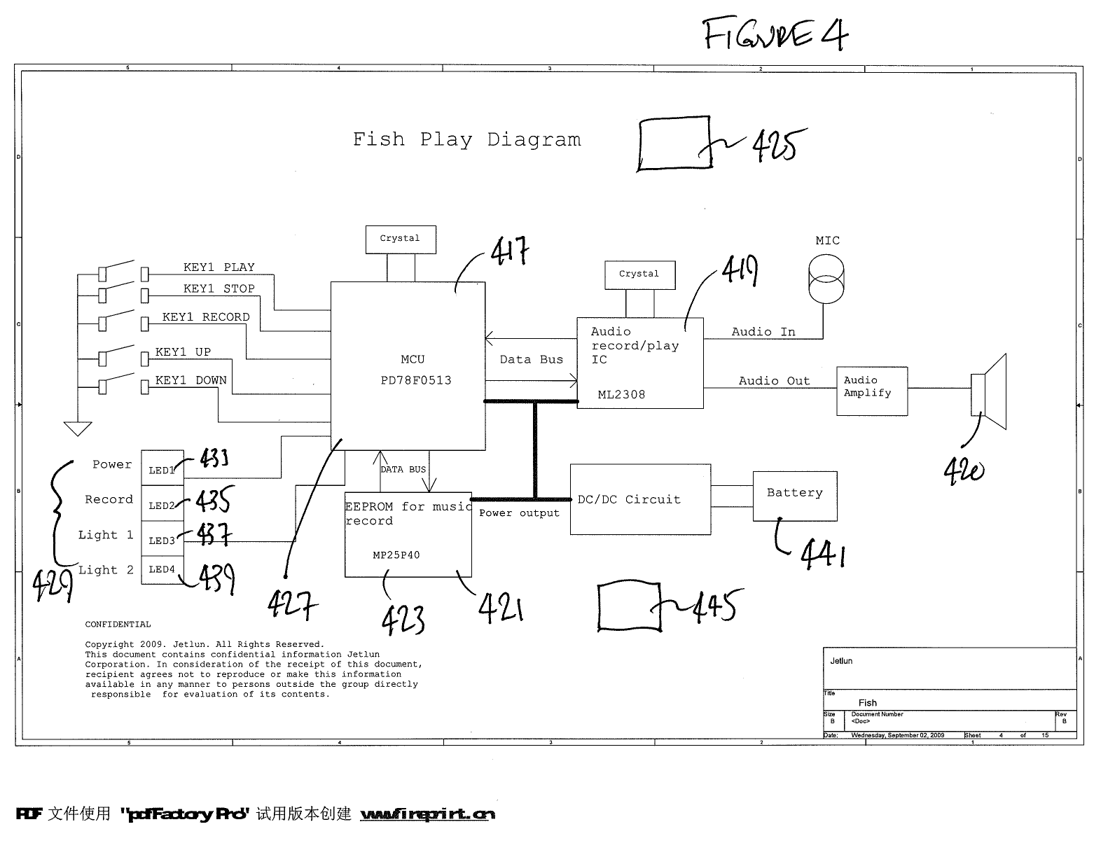

FIG. 4 is a block diagram of an electronic module 400 for the dead stick bait according to an embodiment of the present invention. This diagram is merely an example, which should not unduly limit the scope of the claims herein. One of ordinary skill in the art would recognize other variations, modifications, and alternatives. In a specific embodiment, the electronic module has a processor device 417, an audio module 419 coupled to the processing device, a speaker device 420 coupled to the audio module, and one or more memory devices 421 configured with one of a plurality of audio files 423. In a specific embodiment, the processor device is a central processing unit or MPU, which can be, for example, any suitable multipurpose processing unit, such as the one shown, but can be others. As another example, the audio module is an integrated circuit listed as a 2.5 W Mono Filter Free Class D Audio Power Amplifier such as the TPA2010D1 manufactured by Texas Instruments Incorporated of Texas, but can be others. As an example, the memory device can be a 2 Mbit, low voltage, serial flash memory with a 25 MHz SPi bus interface, such as the M25P20 manufactured by ST Microelectronics, or other companies. Of course, there can be other variations, modifications, and alternatives.

In a specific embodiment, the one or more audio files comprises audio information representative of one or more baits, e.g., bait fish, birds, worms, snakes, crawdad, frogs, bugs. In a specific embodiment, the audio information comprises at least one or more signals representative of a bait, one or more signals representative of a movement of bait, one or more signals in an audio frequency, or the like. In a specific embodiment, the audio information is recorded in an MP3 format or other suitable format. In a specific embodiment, the audio information is also stored in one or more semiconductor memories coupled to the processor device. Depending upon the embodiment, the audio information is selected from one of a plurality of stored audio files, which relates to other respective audio files. As used herein, the audio information can include acoustic, sonic, or other pressure differential information that may be sensed by a predatory fish or the like. Of course, there can be other variations, modifications, and alternatives.

In a specific embodiment, the module includes one or more speaker devices. In a specific embodiment, the speaker devices includes at least one or more piezo speaker devices. In other embodiments, the speaker device can be any suitable energy transfer device for transferring acoustic information into the water for the fish to sense. In preferred embodiments, the speaker device is acoustically coupled to water and transfer audio information. As an example at http://www.ariamarine.com/Fish_%20hearinglish hearing The lower frequency range can be about 10 and 30 Hz that is perceptible through the lateral line mechanoreceptors, which can be responsive to frequencies as high as 300 Hz, but can be others. In other embodiments, the frequency range can be a frequency bandwidth of 30 Hz to around 600 Hz and up to 4 kHz, but can be others for pressure sensitive specialists. Of course, there can be other variations, modifications, and alternatives.

In a specific embodiment, the audio information comprises outputting one or more signals from an off-set micro-motor 425 coupled to the processor device. In a specific embodiment, the off-set micro-motor can be a 3 V DC micro-vibration motor, which has a no-load speed of 13000 RPM, but can be others. In a specific embodiment, the stall torque is (gram centimeter): 5, but can be others. An example of such an off-set micro-motor can be procured from Radio Shack Corporation, or other companies. In a specific embodiment, the one or more signals are mechanical and substantially one or more vibrating signals or combination of acoustic/vibrating signals or the like. Of course, there can be other variations, modification, and alternatives.

In a specific embodiment, the module also includes a lighting module 427 coupled to the processing device according to a specific embodiment. The lighting module is configured to output electromagnetic radiation 429 in one or more of a plurality of wavelengths according to a specific embodiment. In a specific embodiment, the lighting module outputs one or more signals from one or more light emitting diode devices 433, 435, 437, 439. In a specific embodiment, the light emitting diode devices outputs and/or can be blended to output electromagnetic radiation in blue, blue green, green, violet, or ultraviolet. In a specific embodiment, the light emitting diode devices are made using gallium and nitrogen containing light emitting diode devices such as GaN or others. In one or more preferred embodiments, each of the lights is derived from a solid state material such as gallium nitride and the like. In a specific embodiment, the present method uses a polarized light, which is outputted from the gallium and nitrogen containing substrate. In preferred embodiments, the light emitting diodes can be pulsed, continuous, or an irregular pattern or combinations of them. Of course, there can be other variations, modifications, and alternatives.

In one or more embodiments, the module includes an energy source 441 coupled to the processing module. The energy source is configured to provide power to the processing module according to one or more embodiments. In a specific embodiment, the energy source can be a battery, a capacitor, a generator, or a combination of these. The device also has a switching device and/or sensor 445 (e.g., accelerometer, transistor) coupled to at least the processing device according to a specific embodiment. The switching device is configured to turn on the processing device upon selected movement or other internal or external indications of the lure device according to one or more embodiments. In other embodiments, the switching device is configured to also turn off the processing device upon other indications, which may be internal or external. Further details of the present device and be found throughout the present specification and more particularly below.

A dead stick method according to the present invention may be outline as follows:

1. Start;

2. Cast a lure from a fishing rod to a selected spatial location in a body of water or slightly outside of the body of water;

3. Optionally, retrieve the lure;

4. Allow the lure settle, e.g., sink, suspend, or float;

5. Maintain the lure in a substantially motionless state, e.g., laying with little or slight movement or suspended or floating with little or slight movement from the angler;

6. Transfer a combination of audio information and, optionally in a preferred embodiment, electromagnetic radiation from the lure to a region of water surrounding a vicinity of the lure;

7. Entice a predator fish to strike the lure while the lure is in the substantially motionless state;

8. Allow the predator fish to strike;

9. Set the hook on the predator fish;

10. Reel in the fish; and

11. Perform other steps, as desired.

The above sequence of steps provides methods according to an embodiment of the present invention. As shown, the method uses a combination of steps including a way of fishing using a dead stick technique, but can be others. In preferred embodiments, the present invention also includes a fish attracting process using a combination, or alone, electromagnetic radiation and/or acoustic signals, including mechanical vibration and the like. Many other methods and system are also included. Of course, other alternatives can also be provided where steps are added, one or more steps are removed, or one or more steps are provided in a different sequence without departing from the scope of the claims herein. Depending upon the embodiment, there can be other variations, modifications, and alternatives.

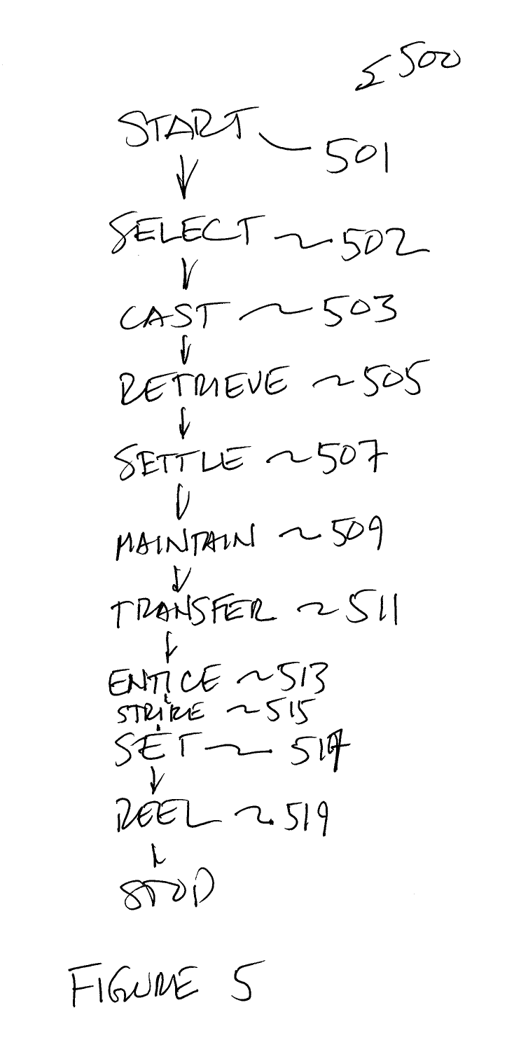

FIG. 5 is a simplified diagram of a method of dead stick fishing according to embodiments of the present invention. These diagrams are merely examples, which should not unduly limit the scope of the claims herein. One of ordinary skill in the art would recognize other variations, modifications, and alternatives. As shown, the method begins with start, step 501. In a specific embodiment, the present method includes a step of selecting (step 502) one of a plurality of lures and/or baits. The lures and/or baits can be those described herein or outside of the present specification. Of course, there can be other variations, modifications, and alternatives.

In a specific embodiment, the method includes casting (step 503) the lure from a fishing rod to a selected spatial location in a body of water or slightly outside of the body of water. In a specific embodiment, the body of water can be a lake, a river, stream, pond, ocean, bay, surf, canal, delta, or other region. Depending upon the embodiment, the selected spatial region can include weeds, grass, rocks, trees, kelp, artificial structures, a bump, a river bed, a road, a dock, or other natural and/or artificial structures. Of course, there can be other variations, modifications, and alternatives.

In one or more embodiments, the method includes retrieving (step 505) the lure, which is optional, or allowing the lure to settle, step 507. In one or more embodiments, the lure is allowed to sink, suspend, or float or any of these in combination, and the like. In one or more preferred embodiments, the lure is maintained (step 509) in a substantially motionless state, e.g., laying with little or slight movement or suspended or floating with little or slight movement from the angler. Of course, there can be other variations, modifications, and alternatives.

Referring now to step 511, the method includes transferring a combination of audio information and, optionally in a preferred embodiment, electromagnetic radiation from the lure to a region of water surrounding a vicinity of the lure. Depending upon the embodiment, the radiation can include blue, violet, blue green, green, or ultraviolet, alone or in combination with others. Additionally, other colors such as red, yellow, orange, and the like may also be used alone or in combination with other colors. In a preferred embodiment, the method entices (step 513) a predator fish to strike the lure while the lure is in the substantially motionless state. In other embodiments, the method entices the fish to strike while the lure is spending, sinking, floating, or a variety of other dead stick states, as well as other slightly moving states. In one or more embodiments, the method allows the predator fish to strike, step 515. The hook is set, step 517. The method has the angler reel in the fish, step 519. Of course, there can be other variations, modifications, and alternatives.

The above sequence of steps provides methods according to an embodiment of the present invention. As shown, the method uses a combination of steps including a way of fishing using a dead stick technique, but can be others. In preferred embodiments, the present invention also includes a fish attracting process using a combination, or alone, electromagnetic radiation and/or acoustic signals, including mechanical vibration and the like. Many other methods and system are also included. Of course, other alternatives can also be provided where steps are added, one or more steps are removed, or one or more steps are provided in a different sequence without departing from the scope of the claims herein. Depending upon the embodiment, there can be other variations, modifications, and alternatives.

In an alternative specific embodiment, a dead stick method for fishing is outlined below.

1. Start;

2. Cast a lure from a fishing rod to a selected spatial location in a body of water or slightly outside of the body of water, e.g., a lake, a river, an ocean, a bay, a pond, or creek;

3. Output one or more signals from the output module using one or more indications from one or more switching devices, which may be coupled to one or more sensor devices, e.g., accelerometer;

4. Attract a predator fish;

5. Allow the predator fish to strike;

6. Set the hook on the predator fish;

7. Reel in the fish; and

8. Perform other steps, as desired.

The above sequence of steps provides methods according to an embodiment of the present invention. As shown, the method uses a combination of steps including a way of fishing using a dead stick technique, but can be others. In preferred embodiments, the present invention also includes a fish attracting process using a combination, or alone, electromagnetic radiation and/or acoustic signals, including mechanical vibration and the like. Many other methods and system are also included. Of course, other alternatives can also be provided where steps are added, one or more steps are removed, or one or more steps are provided in a different sequence without departing from the scope of the claims herein. Depending upon the embodiment, there can be other variations, modifications, and alternatives.

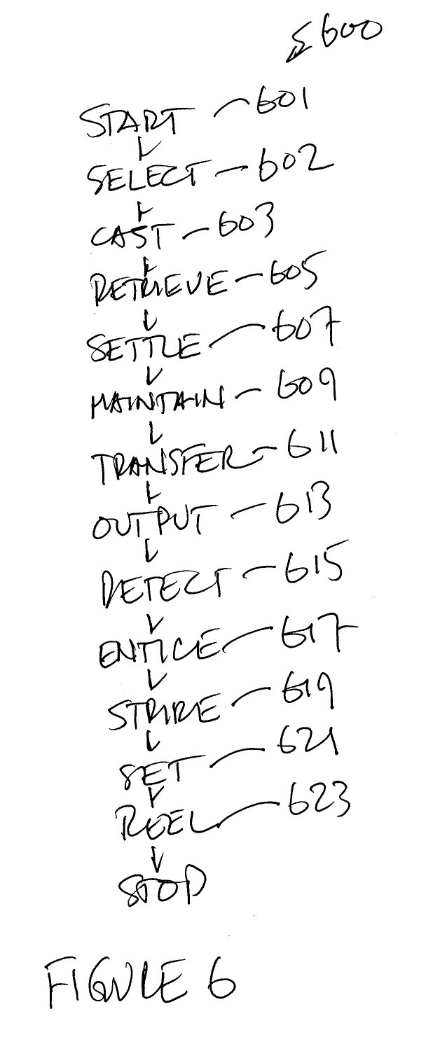

FIG. 6 is a simplified diagram of a method 600 of dead stick fishing according to embodiments of the present invention. These diagrams are merely examples, which should not unduly limit the scope of the claims herein. One of ordinary skill in the art would recognize other variations, modifications, and alternatives. As shown, the method begins with start, step 601. In a specific embodiment, the present method includes a step of selecting (step 602) one of a plurality of lures and/or baits. The lures and/or baits can be those described herein or outside of the present specification. Of course, there can be other variations, modifications, and alternatives.

In a specific embodiment, the method includes casting (step 603) the lure from a fishing rod to a selected spatial location in a body of water or slightly outside of the body of water. In a specific embodiment, the body of water can be a lake, a river, stream, pond, ocean, bay, surf, canal, delta, or other region. Depending upon the embodiment, the selected spatial region can include weeds, grass, rocks, trees, kelp, artificial structures, a bump, a river bed, a road, a dock, or other natural and/or artificial structures. Of course, there can be other variations, modifications, and alternatives.

In one or more embodiments, the method includes retrieving (step 605) the lure, which is optional, or allowing the lure to settle, step 607. In one or more embodiments, the lure is allowed to sink, suspend, or float or any of these in combination, and the like. In one or more preferred embodiments, the lure is maintained (step 609) in a substantially motionless state, e.g., laying with little or slight movement or suspended or floating with little or slight movement from the angler. Of course, there can be other variations, modifications, and alternatives.

Referring now to step 611, the method includes transferring a combination of audio information and, optionally in a preferred embodiment, electromagnetic radiation from the lure to a region of water surrounding a vicinity of the lure. Depending upon the embodiment, the radiation can include blue, violet, blue green, green, or ultraviolet, alone or in combination with others. Additionally, other colors such as red, yellow, orange, and the like may also be used alone or in combination with other colors. Of course, there can be other variations, modifications, and alternatives.

In a preferred embodiment, the method outputs (step 613) one or more signals from one or more output modules using one or more indications from one or more switching devices, which may be coupled to one or more sensor devices, e.g., accelerometer. In one or more preferred embodiments, the lure device has one or more sensor devices coupled to at least one or more processing devices. In a preferred embodiment, the sensor device is a motion sensor such as an accelerometer, which is configured to detect (step 615) one of a plurality of modes. In a preferred embodiment, the motion sensor is configured to output a plurality of indications representing, respectively, the plurality of modes, e.g., sinking, swimming, suspending, floating, casting, jerking, striking, or twitching. Of course, there can be other variations, modifications, and alternatives.

In a preferred embodiment, the method entices (step 617) a predator fish to strike the lure while the lure is in the substantially motionless state. In other embodiments, the method entices the fish to strike while the lure is spending, sinking, floating, or a variety of other dead stick states, as well as other slightly moving states. In one or more embodiments, the method allows the predator fish to strike, step 619. The hook is set, step 621. The method has the angler reel in the fish, step 623. Of course, there can be other variations, modifications, and alternatives.

The above sequence of steps provides methods according to an embodiment of the present invention. As shown, the method uses a combination of steps including a way of fishing using a dead stick technique, but can be others. In preferred embodiments, the present invention also includes a fish attracting process using a combination, or alone, electromagnetic radiation and/or acoustic signals, including mechanical vibration and the like. Many other methods and system are also included. Of course, other alternatives can also be provided where steps are added, one or more steps are removed, or one or more steps are provided in a different sequence without departing from the scope of the claims herein. Depending upon the embodiment, there can be other variations, modifications, and alternatives.

In a specific embodiment, an alternative method of fishing using a deadstick process is outlined as follows:

1. Start;

2. Drift or troll a lure from a fishing rod to one or more selected spatial locations in a body of water according to one or more embodiments;

3. Transfer a combination of at least audio information and electromagnetic radiation from the lure to a region of water within a vicinity of the lure;

4. Entice a predator fish to strike the lure while drifting or trolling the lure from the fishing rod;

5. Allow the predator fish to strike;

6. Set the hook on the predator fish;

7. Reel in the fish; and

8. Perform other steps, as desired.

The above sequence of steps provides methods according to an embodiment of the present invention. As shown, the method uses a combination of steps including a way of fishing using a dead stick technique, but can be others. In preferred embodiments, the present invention also includes a fish attracting process using a combination, or alone, electromagnetic radiation and/or acoustic signals, including mechanical vibration and the like. Many other methods and system are also included. Of course, other alternatives can also be provided where steps are added, one or more steps are removed, or one or more steps are provided in a different sequence without departing from the scope of the claims herein. Depending upon the embodiment, there can be other variations, modifications, and alternatives.

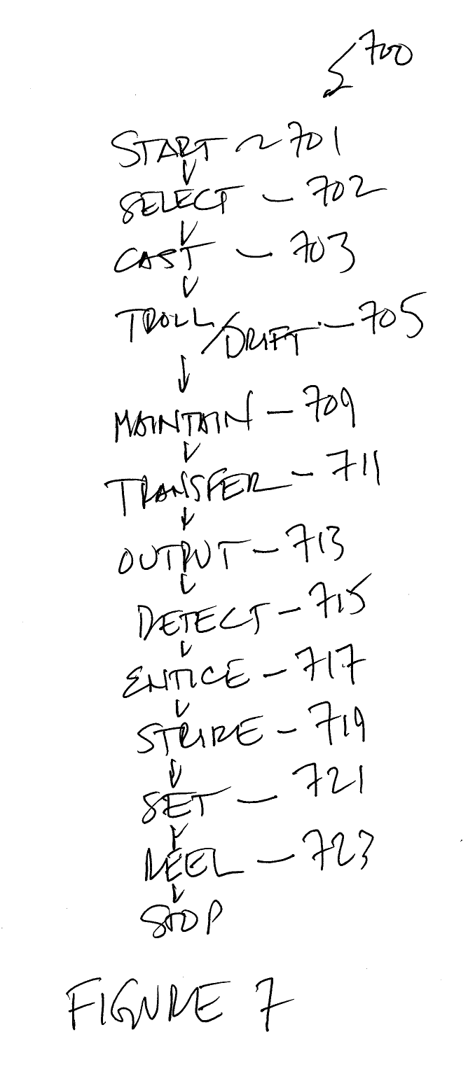

FIG. 7 is a simplified diagram of a method 700 of dead stick fishing according to embodiments of the present invention. These diagrams are merely examples, which should not unduly limit the scope of the claims herein. One of ordinary skill in the art would recognize other variations, modifications, and alternatives. As shown, the method begins with start, step 701. In a specific embodiment, the present method includes a step of selecting (step 702) one of a plurality of lures and/or baits. The lures and/or baits can be those described herein or outside of the present specification. Of course, there can be other variations, modifications, and alternatives.

In a specific embodiment, the method includes casting (step 703) the lure from a fishing rod to a selected spatial location in a body of water or slightly outside of the body of water. In a specific embodiment, the body of water can be a lake, a river, stream, pond, ocean, bay, surf, canal, delta, or other region. Depending upon the embodiment, the selected spatial region can include weeds, grass, rocks, trees, kelp, artificial structures, a bump, a river bed, a road, a dock, or other natural and/or artificial structures. Of course, there can be other variations, modifications, and alternatives.

In one or more embodiments, the method includes drifting or trolling (step 705) the lure from a fishing rod to one or more selected spatial locations in a body of water according to one or more embodiments. In one or more embodiments, the lure may also be retrieved, which is optional, or allowed to settle or sink. In one or more preferred embodiments, the lure is maintained (step 709) in a substantially steady state while drifting and/or trolling according to one or more embodiments. Of course, there can be other variations, modifications, and alternatives.

Referring now to step 711, the method includes transferring a combination of audio information and, optionally in a preferred embodiment, electromagnetic radiation from the lure to a region of water surrounding a vicinity of the lure. Depending upon the embodiment, the radiation can include blue, violet, blue green, or ultraviolet, alone or in combination with others. Additionally, other colors such as red, yellow, orange, and the like may also be used alone or in combination with other colors. Of course, there can be other variations, modifications, and alternatives.

In a preferred embodiment, the method outputs (step 713) one or more signals from one or more output modules using one or more indications from one or more switching devices, which may be coupled to one or more sensor devices, e.g., accelerometer. In one or more preferred embodiments, the lure device has one or more sensor devices coupled to at least one or more processing devices. In a preferred embodiment, the sensor device is a motion sensor such as an accelerometer, which is configured to detect (step 715) one of a plurality of modes. In a preferred embodiment, the motion sensor is configured to output a plurality of indications representing, respectively, the plurality of modes, e.g., sinking, swimming, jerking, striking, twitching, turning. Of course, there can be other variations, modifications, and alternatives.

In a preferred embodiment, the method entices (step 717) a predator fish to strike the lure while the lure is in the substantially motionless state. In other embodiments, the method entices the fish to strike while the lure is spending, sinking, floating, or a variety of other dead stick states, as well as other slightly moving states. In one or more embodiments, the method allows the predator fish to strike, step 719. The hook is set, step 721. The method has the angler reel in the fish, step 723. Of course, there can be other variations, modifications, and alternatives.

The above sequence of steps provides methods according to an embodiment of the present invention. As shown, the method uses a combination of steps including a way of fishing using a dead stick technique, but can be others. In preferred embodiments, the present invention also includes a fish attracting process using a combination, or alone, electromagnetic radiation and/or acoustic signals, including mechanical vibration and the like. Many other methods and system are also included. Of course, other alternatives can also be provided where steps are added, one or more steps are removed, or one or more steps are provided in a different sequence without departing from the scope of the claims herein. Depending upon the embodiment, there can be other variations, modifications, and alternatives.

The various embodiments may be implemented as part of a processor based system or other like system. The system may include an input device, a display unit, and an interface, for example, for accessing the Internet or other network. The system may include a microprocessor. The microprocessor may be connected to a data bus. The system may also include a memory. The memory may include Random Access Memory (RAM) and Read Only Memory (ROM). The system may further include a storage device, which may be a hard disk drive or a removable storage drive such as a floppy disk drive, optical disk drive, jump drive and the like. The storage device can also be other similar means for loading computer programs or other instructions into the system or integrated circuit system or the like. Of course, there can be other variations, modifications, and alternatives.

As used herein, the term “computer” or “processor” may include any processor-based or microprocessor-based system including systems using microcontrollers, digital signal processors (DSP), reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term ‘computer’. The computer system executes a set of instructions that are stored in one or more storage elements, in order to process input data. The storage elements may also hold data or other information as desired or needed. The storage element may be in the form of an information source or a physical memory element within the processing machine.

The set of instructions may include various commands that instruct the processing machine to perform specific operations such as the processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms ‘software’ and ‘firmware’ are interchangeable, and include any computer program stored in memory for execution by a computing device, including RAM memory, ROM memory, EPROM memory, EEPROM memory, and non-volatile RAM (NVRAM) memory. The above memory types are exemplary only, and are thus not limiting as to the types of memory usable for storage of a computer program.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for dead stick fishing comprising:
casting a lure from a fishing rod to a selected spatial location in a body of water or slightly outside of the body of water, the lure comprising at least a processor device coupled to a sound module and coupled to a lighting module;
allowing the lure settle and be substantially motionless state; and
transferring a combination of audio information and electromagnetic radiation from the lure to a region of water surrounding a vicinity of the lure to entice a predator fish to strike the lure while the lure is in the substantially motionless state.

2. The method of claim 1 wherein the body of water is selected from a lake, a river, an ocean, a bay, a pond, or creek.

3. The method of claim 1 wherein the audio information comprises at least one or more signals representative of a bait.

4. The method of claim 1 wherein the audio information comprises at least one or more signals representative of a movement of bait.

5. The method of claim 1 wherein the audio information comprises at least one or more signals in an audio frequency.

6. The method of claim 1 wherein the audio information is recorded in an MP3 format.

7. The method of claim 1 wherein the audio information is stored in one or more semiconductor memories coupled to the processor device.

8. The method of claim 1 wherein the audio information is selected from one of a plurality of stored audio files.

9. The method of claim 1 wherein the transferring of the audio information comprises outputting one or more signals from a piezo speaker device.

10. The method of claim 1 wherein the transferring of the audio information comprises outputting one or more signals from an off-set micro-motor coupled to the processor device.

11. The method of claim 10 wherein the audio information comprises one or more mechanical vibration signals.

12. The method of claim 1 wherein the transferring of the electromagnetic radiation comprises outputting one or more signals from one or more light emitting diode devices.

13. The method of claim 1 wherein the electromagnetic radiation is one or more wavelengths in blue, blue green, green, violet, or ultraviolet.

14. The method of claim 1 wherein the electromagnetic radiation is derived from one or more gallium and nitrogen containing light emitting diode devices.

15. The method of claim 1 wherein the transferring of the electromagnetic radiation is provided in a pulsed, continuous, or irregular pattern.

16. The method of claim 1 wherein the lure is characterized as a soft plastic bait.

17. The method of claim 1 wherein the lure is characterized as a swim bait.

18. The method of claim 1 wherein the lure is characterized as a top water bait.

19. The method of claim 1 wherein the lure is characterized as a jig bait.

20. The method of claim 1 wherein the lure is characterized as a tube bait.

21. A method for fishing comprising:
casting a lure from a fishing rod to a selected spatial location in a body of water or slightly outside of the body of water, the lure comprising at least a processor device coupled to an initiating module and coupled to an output module; and
outputting one or more signals from the output module to attract a predator fish using one or more indications from one or more switching devices, the one or more switching devices being provided within the initiating module.

22. The method of claim 21 wherein the outputting comprising transferring a combination of audio information and electromagnetic radiation from the lure to a region of water surrounding a vicinity of the lure; and further comprising maintaining the lure in the substantially motionless state.

23. The method of claim 21 wherein the one or more switching devices comprises an accelerometer device.

24. The method of claim 21 wherein the one or more switching devices comprises one or more transistor devices.

25. The method of claim 21 wherein the one or more switching devices comprises one or more sensing devices.

26. The method of claim 21 wherein the one or more switching devices comprises one or more MEMS devices.

27. A method of fishing using a dead stick process, the method comprising:
drifting or trolling a lure from a fishing rod to one or more selected spatial locations in a body of water, the lure comprising at least a processor device coupled to a sound module and coupled to a lighting module;
transferring a combination of at least audio information and electromagnetic radiation from the lure to a region of water within a vicinity of the lure; and
enticing a predator fish to strike the lure while drifting or trolling the lure from the fishing rod.

28. The method of claim 27 wherein the body of water is selected from a lake, a river, an ocean, a bay, a pond, or creek.

29. The method of claim 27 wherein the audio information comprises at least one or more signals representative of a bait.

30. The method of claim 27 wherein the audio information comprises at least one or more signals representative of a movement of bait.

31. The method of claim 27 wherein the audio information comprises at least one or more signals in an audio frequency.

32. The method of claim 27 wherein the audio information is recorded in an MP3 format.

33. The method of claim 27 wherein the audio information is stored in one or more semiconductor memories coupled to the processor device.

34. The method of claim 27 wherein the audio information is selected from one of a plurality of stored audio files.

35. The method of claim 27 wherein the transferring of the audio information comprises outputting one or more signals from a piezo speaker device.

36. The method of claim 27 wherein the transferring of the audio information comprises outputting one or more signals from an off-set micro-motor coupled to the processor device.

37. The method of claim 10 wherein the audio information comprises one or more mechanical vibration signals.

38. The method of claim 38 wherein the transferring of the electromagnetic radiation comprises outputting one or more signals from one or more light emitting diode devices.

39. The method of claim 27 wherein the electromagnetic radiation is one or more wavelengths in blue, blue green, green, violet, or ultraviolet.

40. The method of claim 27 wherein the electromagnetic radiation is derived from one or more gallium and nitrogen containing light emitting diode devices.

41. The method of claim 27 wherein the transferring of the electromagnetic radiation is provided in a pulsed, continuous, or irregular pattern.

42. The method of claim 27 wherein the lure is characterized as a soft plastic bait.

43. The method of claim 27 wherein the lure is characterized as a swim bait.

44. The method of claim 27 wherein the lure is characterized as a top water bait.

45. The method of claim 27 wherein the lure is characterized as a jig bait.

46. The method of claim 27 wherein the lure is characterized as a tube bait.

47. A fishing lure device comprising:
a body having a first end and a second end, the body being configured in one of a plurality of shapes representative of a bait;
a module region provided within one or more internal portions of the body between the first end and the second end, the module region comprising:
a processor device;
an audio module coupled to the processing device;
a speaker device coupled to the audio module;
one or more memory devices configured with one of a plurality of audio files, the one or more audio files being audio information representative of one or more baits;
a lighting module coupled to the processing device, the lighting module being configured to output electromagnetic radiation in one or more of a plurality of wavelengths; and
an energy source coupled to the processing module, the energy source being configured to provide power to the processing module; and
a switching device coupled to at least the processing device, the switching device being configured to turn on the processing device upon selected movement of the lure device.

48. A fishing lure device comprising:
a body having a first end and a second end, the body being configured in one of a plurality of shapes;
a module region provided within one or more internal portions of the body between the first end and the second end, the module region comprising:
a processor device;
an audio module coupled to the processing device;
an audio output device coupled to the audio module;
one or more memory devices configured with one of a plurality of audio files;
a lighting module coupled to the processing device, the lighting module being configured to output electromagnetic radiation in one or more of a plurality of wavelengths;
an energy source coupled to the processing module, the energy source being configured to provide power to the processing module; and
a sensor device coupled to at least the processing device, the sensor device being configured to detect one of a plurality of modes.

49. The device of claim 48 wherein the sensor device is a motion sensor, the motion sensor being configured to output a plurality of indications representing, respectively, the plurality of modes.

50. The device of claim 49 wherein the plurality of modes being selected from at least one lure state in group consisting of sinking, swimming, suspending, floating, casting, jerking, striking, or twitching.

51. A method for fishing comprising:
determining at least one of a plurality of outputs based upon at least one of a plurality of inputs derived from one or more sensor devices, each of the inputs representative of a lure state; and
outputting one or more signals from an output module based upon the one of the plurality of inputs to attract a predator fish.

52. The method of claim 51 wherein the outputting comprising transferring a combination of audio information and electromagnetic radiation from the lure to a region of water surrounding a vicinity of the lure; and further comprising maintaining the lure in the substantially motionless state.

53. The method of claim 51 wherein the one or more sensor devices comprises an accelerometer device.

54. The method of claim 51 wherein the one or more sensor devices comprises one or more accelerometer devices.

55. The method of claim 51 wherein the one or more sensor devices comprises one or more accelerometer devices coupled to one or more switching devices.

56. The method of claim 51 wherein the one or more sensor devices comprises one or more MEMS devices.
